(19) United States
(12) Patent Application Publication
(10) Pub. No.: US 2026/0221814 A1
(43) Pub. Date: Jul. 30, 2026

(54) BRUSHLESS DC MOTOR FOR USE AT HIGH TEMPERATURES

(71) Applicant: Moog Controls Ltd., Tewkesbury (GB)

(72) Inventors: Daniel Burden, Gloucestershire (GB); Christopher John Williams, Gloucestershire (GB)

(21) Appl. No.: 19/152,045

(22) PCT Filed: Jan. 31, 2024
(86) PCT No.: PCT/GB2024/050272

§ 371 Date: Jul. 30, 2025

(30) Foreign Application Priority Data
Feb. 2, 2023 (GB) 2301532.4

(51) Int. Cl. H02K 1/16; H02K 1/278; H02K 3/02; H02K 3/28; H02K 3/30; H02K 3/34; H02K 7/08

(52) U.S. Cl. CPC H02K 1/16; H02K 1/278; H02K 3/02; H02K 3/28; H02K 3/30; H02K 3/345; H02K 7/083; H02K 2203/09

(57) ABSTRACT

A stator for a brushless DC motor, the stator comprising: a plurality of coil windings; and a layered stack of laminations positioned around a centre axis, wherein the layered stack of laminations defines an annular shape, and wherein each lamination from the layered stack of laminations has: a first plurality of teeth, wherein the first plurality of teeth extend radially towards the centre axis and define a first plurality of channels between the first plurality of teeth, wherein each channel of the first plurality of channels is configured to receive at least a portion of a coil winding; a second plurality of teeth, wherein the second plurality of teeth extend radially away from the centre axis and define a second plurality of channels between the second plurality of teeth, wherein each channel of the second plurality of channels is configured to receive at least a portion of a coil winding; and wherein each of the first plurality of channels and the second plurality of channels is provided with a layer of electrically insulating ceramic material such that each coil winding of the 15 plurality of coil windings is electrically isolated from the layered stack of laminations.

### FIELD OF THE INVENTION

The invention relates to motors capable of operating in high temperature environments, in particular brushless direct current, DC, motors for aerospace or other applications.

### BACKGROUND OF THE INVENTION

There is a growing need to provide electric motors capable of operating at high temperatures. For example, aircraft manufacturers are looking to use alternative fuels such as biofuels and synthetic fuels to reduce carbon emissions. These alternative fuels may preclude the use of conventional fuel-draulic actuation typically used in gas-turbine engines, and therefore necessitate more direct electromechanical actuation. This in turn requires more electric motors to be used in electric actuators for example, and in a higher temperature environment than they are typically used in. Further, efforts to increase engine cycle efficiency often involve increasing compression ratios, meaning that any electric motors used in actuating components within the gas turbine engine are subjected to yet higher temperatures. Electric motors used in propulsion motors may also be required to operate under high temperatures.

Motors capable of operation at high temperature are also required where the ambient temperature is moderate but self-heating is very high. For example, the higher the temperature at which the motor can operate, the higher the current density (and hence torque or power) the motor can run on without the need to provide an active cooling system. In an aerospace context, such a cooling system not only adds cost, but also add mass and is another component that must meet reliability requirements.

Most conventional motors are limited in the maximum temperatures they can operate. For example, conventional motors cannot typically operate at temperatures of 400 degrees Celsius or higher due to melting or degradation of materials used for electrical insulation etc.

To provide electrical insulation at high temperatures generally, it is known to coat wires with proprietary coatings made from glass or ceramic. These wires can operate at high temperatures on their own. To improve the operability of motors at high temperatures, ceramic cement may be used as a potting compound in motors, as described in US 2013134809.

JP 2004147470 discusses a plate-shaped stator composed of laminated ceramic layers for a brushless motor. Alumina is used for the laminated layers. The components of the stator are connected using solder. US 2010045121 discusses a motor for high temperature applications above 460 degrees Celsius. The rotor and the stator are built up from a stack of laminations made of a high temperature rare-earth permanent magnetic alloy. The stator windings are bonded together with an electrically resistant adhesive made of a ceramic binder.

However, the above designs have a number of problems. Wire pre-coated in ceramic or glass is easily damaged during winding, with the insulating layer being broken or removed when the wire is bent, and is not a robust solution. Further, the ceramic potting may not provide adequate heat transfer in the motor. There is a need for high temperature motors which can operate and survive in high temperature environments, such as at or above 400 degrees Celsius.

There is a need to provide an electric motor with a higher temperature capability than a conventional motor.

### SUMMARY OF THE INVENTION

Aspects and embodiments of the invention provide a brushless DC motor capable of operating in high temperature environments. The present invention introduces a way to design motors such that they can withstand temperatures of and above 400 degrees Celsius.

According to a first aspect of the invention there is provided a stator for a brushless DC motor, the stator comprising: a plurality of coil windings; and a layered stack of laminations positioned around a centre axis, wherein the layered stack of laminations defines an annular shape, and wherein each lamination from the layered stack of laminations has: a first plurality of teeth, wherein the first plurality of teeth extend radially towards the centre axis and define a first plurality of channels between the first plurality of teeth, wherein each channel of the first plurality of channels is configured to receive at least a portion of a coil winding; a second plurality of teeth, wherein the second plurality of teeth extend radially away from the centre axis and define a second plurality of channels between the second plurality of teeth, wherein each channel of the second plurality of channels is configured to receive at least a portion of a coil winding; and wherein each of the first plurality of channels and the second plurality of channels is provided with a layer of electrically insulating ceramic material such that each coil winding of the plurality of coil windings is electrically isolated from the layered stack of laminations.

Such an apparatus allows for a robust and electrically insulated stator component which is able to operate in a motor at high temperatures.

Optionally the apparatus further comprising a lamination end cap, wherein the lamination end cap has an annular shape positioned around the centre axis adjacent to the layered stack of laminations, further wherein the lamination end cap has a curved ceramic surface with a curvature about an annular axis.

Advantageously, the curved ceramic surface facilitates easier manufacture, allowing portions of metal to be bent over the surface to form a coil winding which is electrically insulated from the stator components.

Optionally a first coil winding of the plurality of coil windings has a substantially U-shaped section including an inside leg, an outside leg, and a curved portion wherein the inside leg of the first coil winding of the plurality of coil windings lies within one of the first plurality of channels, the outside leg of the first coil winding of the plurality of coil windings lies within one of the second plurality of channels, and the curved portion of the first coil winding of the plurality of coil windings sits adjacent to the curved ceramic surface.

Optionally the lamination end cap has a half torus shape.

Optionally the apparatus further comprises one or more connecting means arranged such that the inside leg of the first coil winding of the plurality of coil windings is connected to an outside leg of a second coil winding of the plurality of coil windings different to the first coil winding.

Optionally the one or more connecting means is one or more busbars welded to an end of the inside leg of the first coil winding of the plurality of coil windings and welded to an end of the outside leg of the second coil winding of the plurality of coil windings.

Optionally the layer of electrically insulating ceramic material comprises one or more inserts of solid ceramic material and/or a vapor deposition coating. The ceramic components provide electrical insulation between the laminations and the coil windings. Individual laminations are optionally also coated with an electrically insulating ceramic material, so as to provide electrical insulation between laminations.

Optionally each coil winding of the plurality of coil windings is formed from copper plated with nickel, or alternatively silver or gold. This mitigates the formation of a black oxide coating on the wire thereby providing a more stable surface than uncoated copper.

Preferably the apparatus further comprises: a first plate formed from ceramic or coated with ceramic; a first conductive busbar positioned on the first plate; a second plate formed from ceramic or coated with ceramic; and a second conductive busbar positioned on the second plate, wherein each of the plurality of coil windings has an elongate portion, wherein a first elongate portion of a first coil winding and a second elongate portion of a second coil winding are connected via the first conductive busbar, and further wherein a third elongate portion of a third coil winding and a fourth elongate portion of a fourth coil winding extend through the first plate and are connected via the second conductive busbar.

Advantageously, this configuration enables the windings of each motor phase to be connected together whilst preventing wiring turns from different motor phases from contacting one another. The configuration also improves the cooling of the coil windings on the stator.

Optionally the layer of electrically insulating ceramic material is one or more of alumina, aluminium nitride or magnesium oxide. The ceramic material has a reasonably high thermal conductivity thus mitigating self-heating of the stator.

According to a second aspect of the invention there is provided a rotor for a brushless DC motor, the rotor comprising: a shaft positioned around a centre axis, the shaft comprising a plurality of axially extending slots (e.g. dovetail slots), the slots having an annular width that decreases radially towards an opening; a plurality of pole pieces spaced at intervals around the shaft and extending radially away from the centre axis, wherein each pole piece of the plurality of pole pieces comprises a radially extending portion (e.g. a dovetail) configured to be slotted axially into a corresponding slot of the plurality of slots, wherein the radially extending portion has a cross section shaped to correspond with a cross section of the slot; and a plurality of magnets, wherein each magnet of the plurality of magnets is positioned between a first pole piece and second pole piece of the plurality of pole pieces.

This configuration provides an interference fit thus allowing the use of adhesive (which might degrade at very high temperatures) in the rotor assembly to be avoided.

Optionally each magnet of the plurality of magnets is shaped to define a wider portion closer to the centre axis and a narrower portion further (i.e. radially further than the wider portion) from the centre axis (i.e. the first portion has a larger annular width), and further wherein each pole piece is shaped to define a narrower region closer to the centre axis and a wider region further (i.e. radially further than the narrower portion) from the centre axis (i.e. the first region has a smaller annular width) such that the plurality of magnets are mechanically retained by the plurality of pole pieces under rotation of the rotor.

Optionally each magnet of the plurality of magnets is wedge shaped.

Optionally each of the plurality of magnets are biased against the plurality of pole pieces by means of a resiliently deformable member positioned between each of the plurality of magnets and the shaft. In some embodiments, the deformable member comprises a metallic spring pin.

According to a third aspect of the invention there is provided a brushless DC motor comprising the rotor and/or the stator described above. Preferably the motor comprises a housing surrounding the rotor and stator. Preferably an inside surface of the housing is also provided with a layer of electrically insulating ceramic material (for example coated to the housing using vapour deposition) so as to electrically insulate the housing from the coil windings.

Optionally the motor comprises a first bearing and a second bearing, wherein the first bearing is fixed axially relative to the shaft and the second bearing is axially movable relative to the shaft; and an axially resiliently deformable member; wherein the axially resiliently deformable member is configured to apply an axial force to the second bearing, which is transmitted through the rotor, to the first bearing. Advantageously this arrangement allows for thermal expansion of the motor components without subjecting component parts to excessive mechanical stress.

Optionally the motor further comprises a spacer surrounding a portion of the shaft and positioned so as to separate the second bearing from the plurality of pole pieces and the plurality of magnets. The spacer extends radially from the shaft such that a radially outermost edge of the spacer lies at a greater radial distance from the shaft than a radially innermost portion of the plurality of pole pieces and a radially innermost portion of the plurality of magnets. In further embodiments, a corresponding spacer may also be provided to separate the first bearing from the plurality of pole pieces and the plurality of magnets. Advantageously, as well as providing a means to transmit the axial force from the axially resiliently deformable member via the second bearing to the rotor and on to the first bearing, the spacer (or spacers) provides an additional means for axially retaining the plurality of pole pieces and the plurality of magnets.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which like reference numerals refer to like components throughout:

FIG. 1 shows a perspective view of a stator configuration according to an aspect of the invention;

FIG. 2a shows a first perspective view of the stator configuration of FIG. 1 with a coil winding according to an aspect of the invention;

FIG. 2b shows a second perspective view of the stator configuration with coil winding of FIG. 2a according to an aspect of the invention;

FIG. 3 shows a curved ceramic surface according to an aspect of the invention;

FIG. 4 shows a ceramic insert comprising a single channel according to an aspect of the invention;

FIG. 5a shows the stator configuration of FIGS. 1 to 2b with a first ceramic plate according to an aspect of the invention;

FIG. 5b shows the stator configuration of FIG. 5a with a second ceramic plate according to an aspect of the invention;

FIG. 5c shows a stator configuration of FIG. 5b with a third ceramic plate according to an aspect of the invention;

FIG. 5d shows a stator configuration of FIG. 5c with a final ceramic plate according to an aspect of the invention;

FIG. 6 shows a rotor configuration according to an aspect of the invention;

FIG. 7 shows a cross section of a portion of the rotor configuration shown in FIG. 6 according to an aspect of the invention;

FIG. 8 shows a cross section of a brushless DC motor according to an aspect of the invention.

### DETAILED DESCRIPTION

The present invention provides an improved stator component for a motor and an improved rotor component for a motor. The invention allows the motor to operate at high temperatures such as those at or above 400 degrees Celsius. In particular, but not exclusively, the present invention may be used in brushless DC motors. The stator comprises one or more ceramic components such that the components making up the stator are electrically isolated from one another. The use of the ceramic components enables the motor to function at high temperatures while remaining electrically insulated. The rotor of the invention is configured to enable the components to interlock with one another. This allows the rotor to be assembled without the use of adhesive thus allowing the motor to operate at high temperatures. For ease of understanding, the terms ‘stator’ and ‘rotor’ are used throughout. It is to be understood that the stator discussed herein may rotate as part of the motor and the rotor described herein may be stationary as part of the motor.

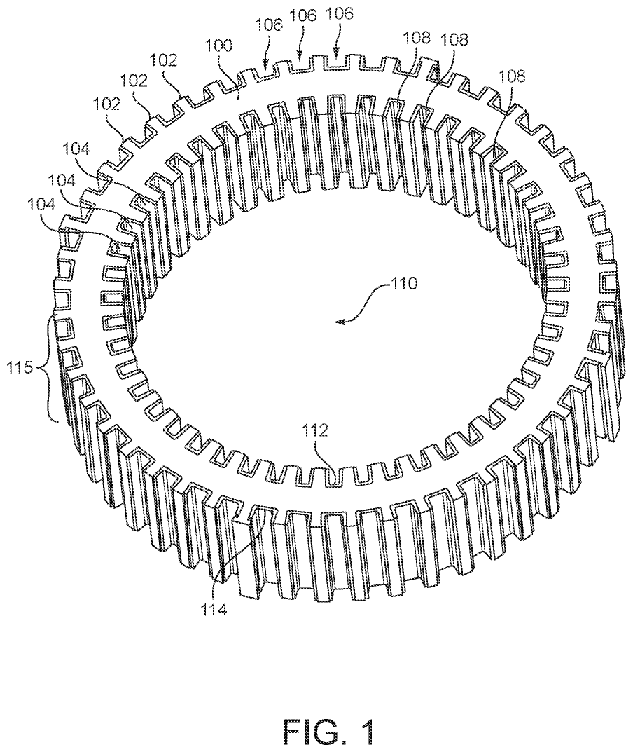

FIGS. 1 to 5d show the stator of a motor, and components thereof, at various stages of assembly in accordance with an embodiment of the present invention.

FIG. 1 shows perspective view of a stator configuration in accordance with an embodiment of the invention. The stator is made up from a layered stack of laminations 115. Any suitable number of laminations may be chosen based on the particular application of the motor. Each lamination 100 is of an annular shape such that an opening 110 is provided to accommodate a rotor (though it will be appreciated the opening may take other shapes if desired). Each lamination 100 comprises an inner circumference 112 and an outer circumference 114. On the inner circumference 112, there is provided a first plurality of teeth (e.g. protrusions/projections) 104 which extend substantially radially towards a centre axis of the lamination 100. On the outer circumference 114, there is provided a second plurality of teeth (protrusions/projections) 102 which extend radially outwards away from the centre axis of the lamination 100. The first plurality of teeth 104 are optionally aligned with the second plurality of teeth 102 such that each one of the first plurality of teeth 104 is directly opposite one of the second plurality of teeth 102. In one example, each lamination 100 may be made from steel.

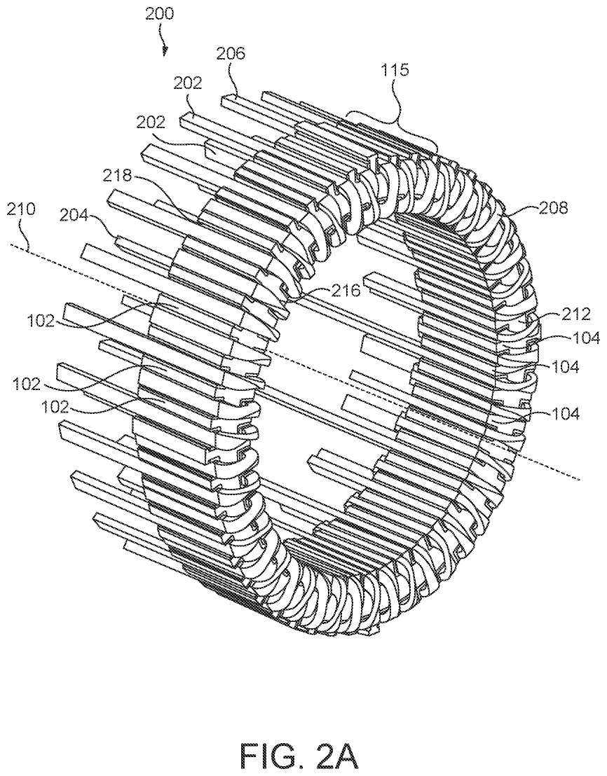

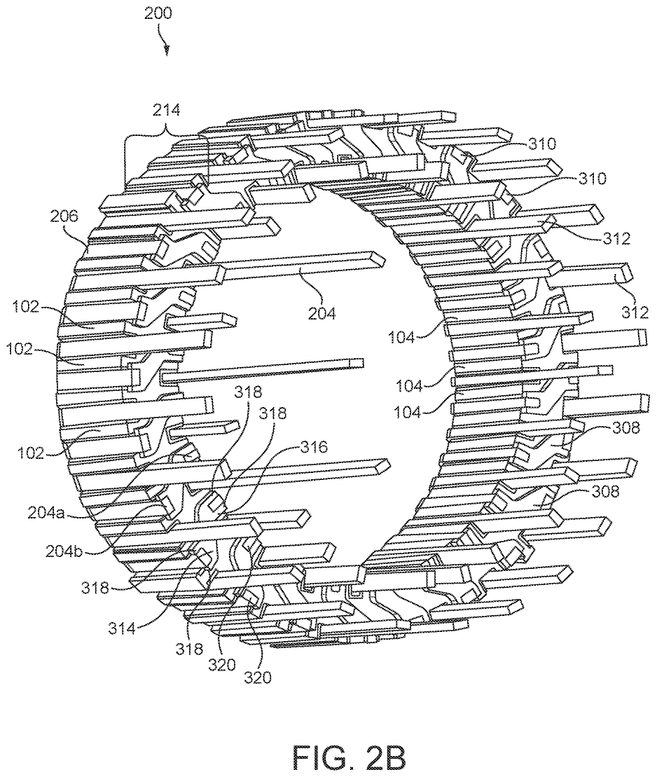

In use, a plurality of laminations 100 are stacked on top of one another such that they are aligned axially to form a layered stack of laminations 115. When two or more laminations 100 are positioned together to form a layered stack of laminations 115, the first plurality of teeth 104 of a first lamination 100 are aligned with the first plurality of teeth 104 of the other laminations in the layered stack of laminations 115. The second plurality of teeth 102 of the first lamination 100 are aligned with the second plurality of teeth 102 of the other laminations in the layered stack of laminations 115. In this way, a first plurality of channels 108 is formed between pairs of the first plurality of teeth 104 and a second plurality of channels 106 is formed between pairs of the second plurality of teeth 102. Preferably, the first plurality of channels 108 and the second plurality of channels 106 run in a substantially axial direction (i.e., substantially parallel to an axis of the motor 210 as shown in FIG. 2a).

In an alternative embodiment, each lamination 100 is stacked at a progressively increasing angle about the motor axis relative to the adjacent lamination, such that the first and second plurality of teeth 104, 102 define first and second pluralities of channels 108 extending at an angle to the axis of the motor. In other words, though all the laminations 100 are stacked concentrically with the motor axis, the teeth 104, 102 are misaligned angularly about the motor axis such that the channels 108 are slanted relative to the axial direction (though not slanted radially). Such canting of the channels and hence coil windings beneficially reduces magnetic cogging effects.

Each of the first plurality of channels 108 and the second plurality of channels 106 is configured to accommodate a length of wire that carries electrical current in use.

FIG. 2a shows a layered stack of laminations 115 formed from a plurality of laminations shown in FIG. 1, with coil windings in accordance with an embodiment of the invention.

FIG. 2a shows a coil assembly 200 including the layered stack of laminations 115 as described above, with coil windings wrapped over an end of the layered stack of laminations 115 between the first plurality of teeth 104 and the second plurality of teeth 102.

As used herein, a coil winding turn refers to a length of electrically conductive wire that has at least a portion extending along the inside of the laminations and a portion extending along the outside of the lamination. The arrangement shown in FIG. 2a, each turn 202 comprises a first segment, a substantially U-shape segment, and a second segment as discussed in further detail below.

The layered stack of laminations 115 is electrically insulated from the coil winding turns by means of a non-conductive ceramic layer. Advantageously, the ceramic layer in combination with the first and second plurality of channels 106, 108 allows for the turns 202 to be fully insulated from both each other and the laminations 115, while avoiding traditional insulating sleeves and coatings that would degrade at very high temperatures.

In a first example, one or more laminations of the layered stack of laminations 115 are coated with a ceramic material using a vapour deposition method (for example, a thermal spraying process). Preferably, each lamination 100 of the layered stack of laminations 115 is coated with the ceramic material. In this case, the coating is preferably applied to each lamination 100 individually such that all faces of each lamination 100 is coated. This additionally provides lamination 100 to lamination 100 electrical insulation.

In a second example, the laminations are coated after the layered stack of laminations 115 has been assembled.

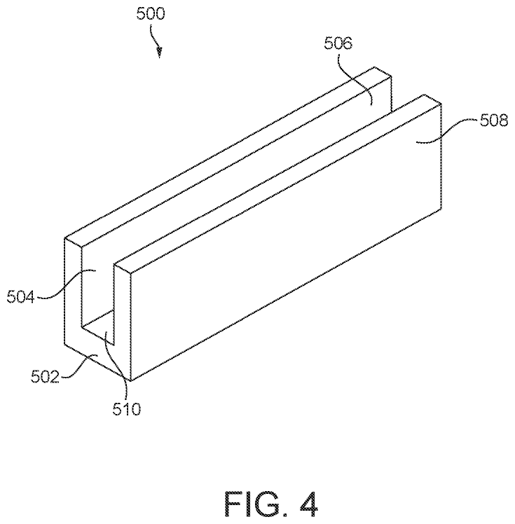

In a third example, ceramic inserts 500 (for example, a ceramic liner) as shown in FIG. 4 are placed within each of the first plurality of channels 108 and the second plurality of channels 106. As shown in FIG. 4a, each ceramic insert 500 has a U-shaped cross section 502 defining a first side 506, a second side 508 and a bottom surface 510, shaped to receive a length of wire within it, and to fit within its respective channel 106, 108, as discussed in detail below. Preferably, the ceramic insert 500 is made from alumina, aluminium nitride or magnesium oxide. Use of a ceramic insert 500 electrically insulates the stator from each wiring turn (coil winding turn 202).

In a fourth example, a ceramic cement potting compound is positioned around the coil winding turns 202 instead of or in addition to the ceramic insert 500.

It will be appreciated that the examples of ceramic insulation layers above may be provided together in various combinations. For example, each lamination 100 may be cut (e.g., using EDM or laser cutting techniques) from a sheet pre-coated in non-conductive ceramic to insulate the lamination 100 from adjacent laminations, and a ceramic insert 500 used to electrically isolate the coil windings 202 from the non-coated edges of the laminations 100.

The laminations 100 are optionally fixed to one another (for example after coating with non-conductive ceramic) via laser welding.

Preferably, the ceramic material in the examples above is alumina, aluminium nitride or magnesium oxide. Advantageously, alumina has an acceptably high thermal conductivity of between 12 W/m·K and 38.5 W/m·K and aluminium nitride has an even higher thermal conductivity of up to 321 W/m·K, thus mitigating self-heating of the stator during operation.

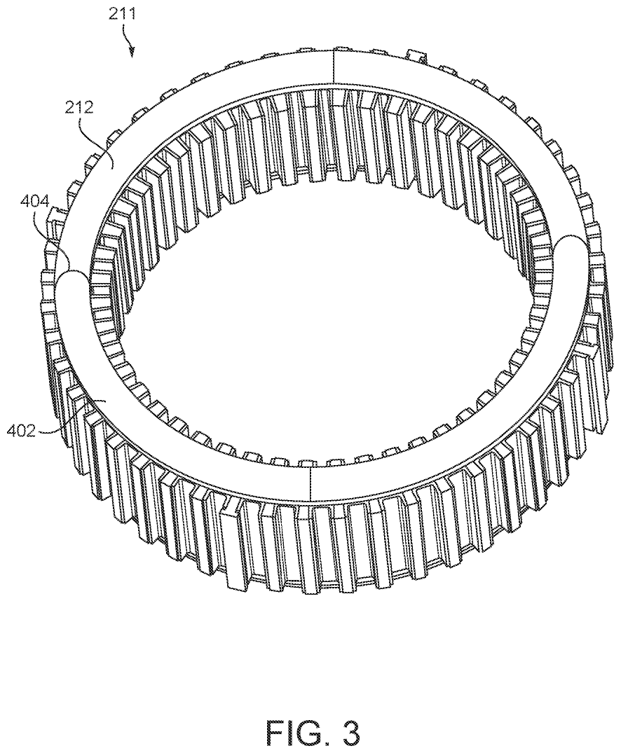

In the preferred embodiment, there is provided a lamination end cap 211 comprising a curved ceramic surface 212 (as best shown in FIG. 3), positioned at a first end 216 of the layered stack of laminations 115. The curved ceramic surface 212 is positioned annularly so as to substantially cover the first end 216 of the layered stack of laminations 115 without obstructing the opening 110. The curved ceramic surface 212 has a curvature about an annular axis. Preferably, the curved ceramic surface 212 defines a half-torus shape, as shown in FIG. 3. Advantageously, the curved ceramic surface 212 provides an electrically insulating former/support over which wire is bent when forming a turn 202, allowing heavy gauge wire (i.e. wire with a large cross sectional area) to be accurately and consistently bent into the correct shape for a turn. This in turn enables the stator to carry high currents using fewer turns 202. For example, the cross sectional area of the wire in each term may be 5 mm², and capable of carrying currents of 105A (RMS) in use. It will be appreciated that the exact cross-sectional area of the wire can be chosen according to the required current load, expected ambient temperature etc. Thus use of heavy gauge wire further is beneficial for allowing heat to transfer away from the stator assembly. The curved ceramic surface 212 further acts to electrically insulate each wiring turn from the stack of laminations 115. In this way, a substantially U-shaped segment 208 of each coil winding turn 202 is arranged to curve over the curved ceramic surface 212 such that the curvature of the curved ceramic surface 212 aligns with the curvature of the U-shape segment 208 of each coil winding turn 202.

Traditional organic-based insulation coatings/sleeves degrade at high temperatures. In the present invention such coatings/sleeves are not used. In one example, copper wires having no coating are used. Alternatively, to mitigate the formation of a coating of oxidised material on the wire during operation, the wire is optionally plated with a different metal less susceptible to oxidation, for example Nickel.

The shape of each of the coil winding turns 202 is defined by the geometry of the laminations 115 and the curved ceramic surface 212. In the illustrated embodiment, each coil winding turn 202 is formed of a first segment 204 (also referred to as an inside leg below) which is positioned within one of the first plurality of channels 108, a substantially U-shaped segment 208 (e.g., a curved portion) which bends over the curved ceramic surface 212 at a first end 216 of the layered stack of laminations 115 (thereby reversing the axial direction of the winding), and a second segment 206 (also referred to as an outside leg) which is positioned within one of the second plurality of channels 106. The U-shape segment 208 connects the first segment 204 of the coil winding turn 202 to the second segment 206 of the coil winding turn 202. Preferably, the second segment 206 of each coil winding turn 202 lies within the corresponding second channel 106 to the first channel 108. For example, the second segment 206 of each coil winding turn 202 lies within one of the second plurality of channels 106 directly opposite a corresponding one of the first plurality of channels 108 containing the first segment 204. Accordingly, each winding turn 202 extends in a first substantially axial direction along a channel 108 on the inner circumference 112 of the stack of laminations 115 and is bent around the curved ceramic surface 212 to extend in a second substantially axial direction opposite the first direction along a channel 106 on the outer circumference 114 of the stack of laminations 115.

As shown, the first segment 204 and the second segment 206 are substantially straight and substantially parallel to each other. In other examples, other configurations are possible.

In an example, the curved ceramic surface 212 (i.e., the lamination end cap) may be made from four parts 402 fabricated by 3D printing as shown in FIG. 3. The four parts 402 may optionally include interlocking features at a joint 404 between the parts 402, such as a dovetail joint or interlocking teeth to allow the parts 402 to interlock to form a complete circle, for example. More or less parts may be used to form the curved ceramic surface 212. For example, the curved ceramic surface 212 may be formed from a single part.

As an alternative, the lamination end cap may be formed from an electrically insulating ceramic material having a different shape, for example a ring having a rectangular or other shaped cross section.

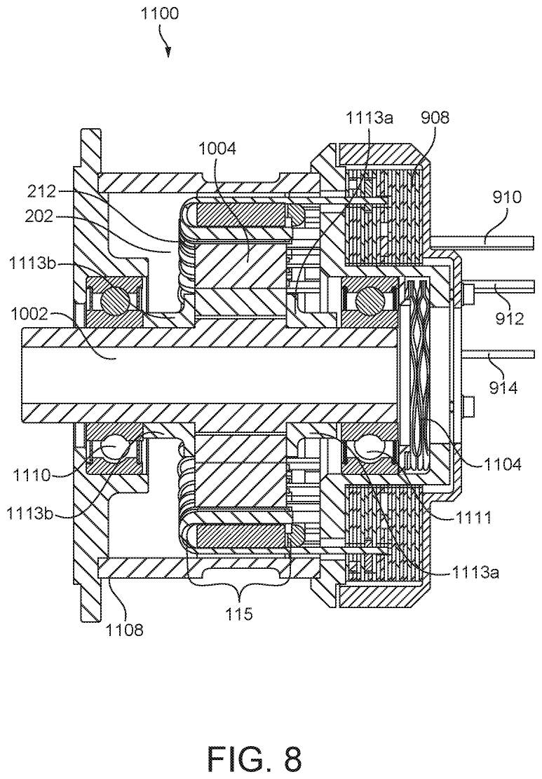

Preferably, in use the outside leg (i.e., the second segment) 206 of each coil winding turn 202 runs in close proximity to an outer casing (housing) 1108 of an assembled motor as shown in FIG. 8. This is beneficial for dissipating heat away from the interior of the motor 1100.

FIG. 2b shows the layered stack of laminations 115 with coil winding turns 202 as described with respect to FIG. 2a. FIG. 2b additionally shows the connections 308 between adjacent pairs of coil winding turns 202.

FIG. 2b shows the same features as FIG. 2a with the addition of a plurality of connecting means 308. In this embodiment, the connecting means 308 take the form of a conductive member (again, bare copper having a cross sectional area of around 5 mm² can be used, but the precise choice can be tailored to the current, operating temperature and loss characteristics required for the motor). Each connecting means 308 is shaped to comprise an elongate conductive member having a first distal end 314 and a second distal end 316, each distal end having two arms 318. Each pair of arms 318 defines a recess 320 between them configured to receive portions of the coil winding turns 202. Each recess 320 is configured to receive an inside leg of a first coil winding 204a and an outside leg of a second, different coil winding 204b. Each connecting means 308 connects a first segment (inside leg) of the first coil winding 204a to a second segment (outside leg) of the second (preferably adjacent) coil winding 204b. For example, an inside leg of a first coil winding 204a is connected to an outside leg of a different adjacent coil winding 204b. Connecting in this way provides a convenient manufacturing method for allowing multiple turns of large cross section wire to be turned around a layered stack of laminations 115. In instances where the connected portions of wire extend further than the connecting means 308, the segments which are connected via the connecting means 308 are shortened such that the connecting legs no longer extend past the connecting means 308. In this way, each length of wire forming a coil winding turn 202 has a shorter connected leg 310 and an extended unconnected leg 312.

Coil winding pairs (i.e., a first segment of a first coil winding 204a and a second segment of a different coil winding 204b) are connected with a weld joint between the inner leg of the first coil winding 204a and the connecting means 308 and a weld joint between the outer leg of the second coil winding 204b and the connecting means 308. The weld joint (for example made using a TIG welding process) preferably uses the same material as the connected leg for the weld material (in the illustrated example, copper). Advantageously, such welding avoids the need for soldering of parts, which solder would typically melt at operating temperatures of 400 degrees Celsius or over.

FIG. 4 shows a ceramic insert 500 in accordance with an embodiment of the invention which can be inserted in the first plurality of channels 108 and the second plurality of channels 106.

As described above, the ceramic insert 500 is formed, for example, from alumina or magnesium oxide. The ceramic insert 500 has a substantially flat bottom 510 with orthogonal sides 506, 508 as shown in FIG. 4. The skilled person will appreciate that other designs are possible depending on the shape of the channels 106, 108 and the teeth 102, 104 of the stator, and of the cross section of the windings 202. In the illustrated example, the ceramic insert 500 provides a substantially square-bottomed U-shaped cross section 502. This shape allows the ceramic insert 500 to fit within the channels 106, 108 of the stator laminations 115 as shown in FIGS. 2a-b such that the coil winding turns 202 are electrically insulated. Each ceramic insert 500 provides a channel 504 for receiving a length of wire of a respecting coil winding turn 202.

In an alternative example, a ceramic insert can be formed to allow multiple (for example, 2 or 3) coil winding turns 202 within a single channel 106, 108. For example, the ceramic insert could be formed as one or multiple pieces which allow the insert to receive multiple coil winding turns 202. This would effectively result in a stack of ceramic inserts 500 formed of one or more pieces. Any suitable number of channels may be formed to receive a corresponding number of coil winding turns 202.

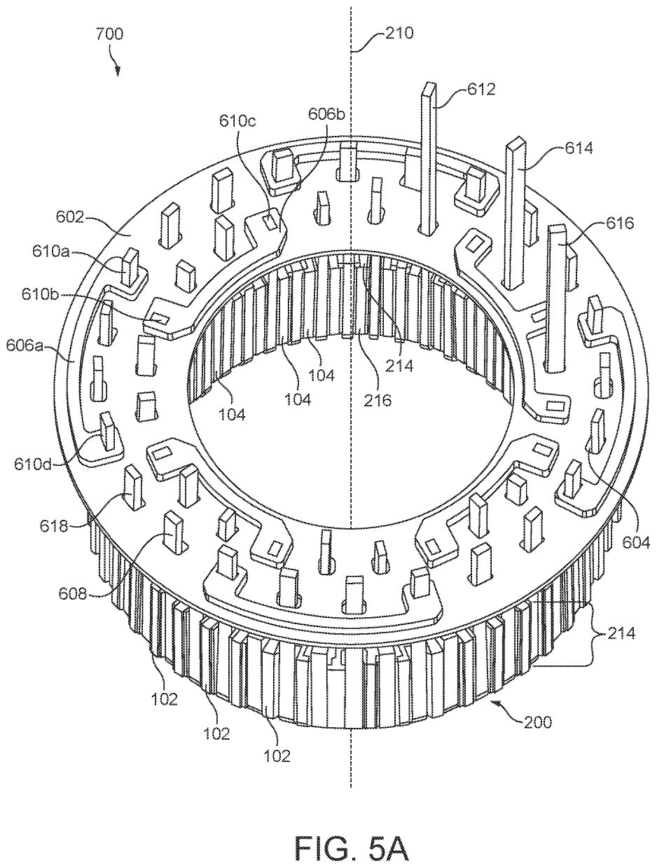

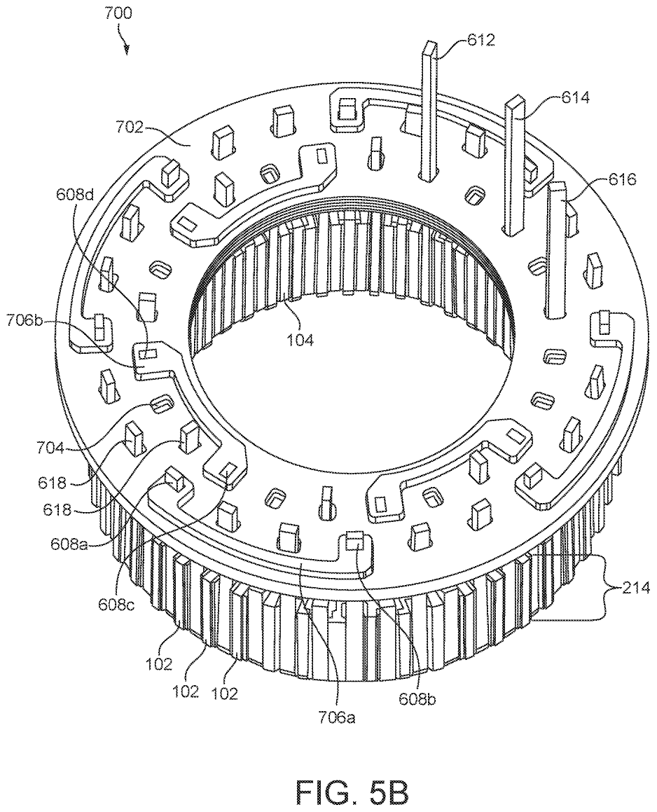

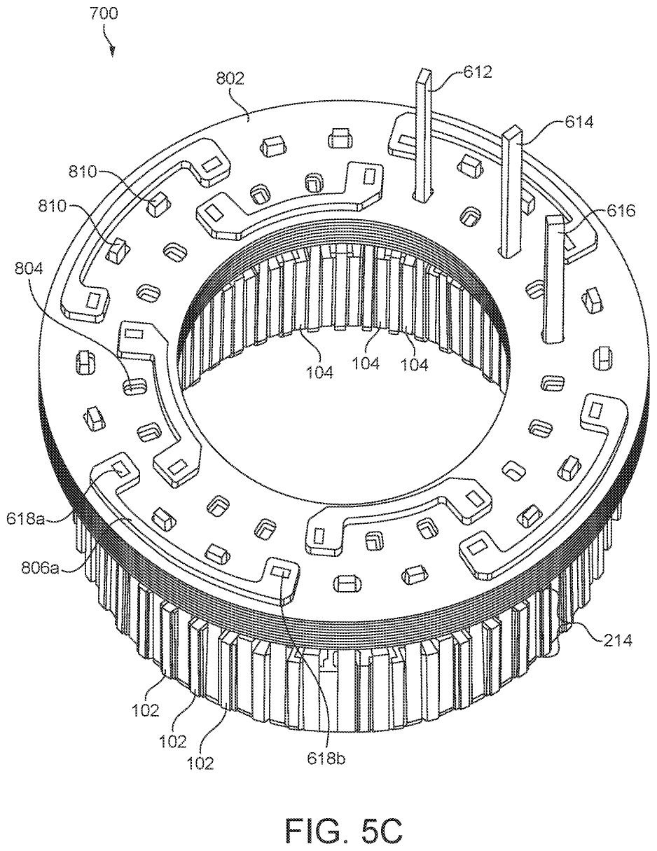

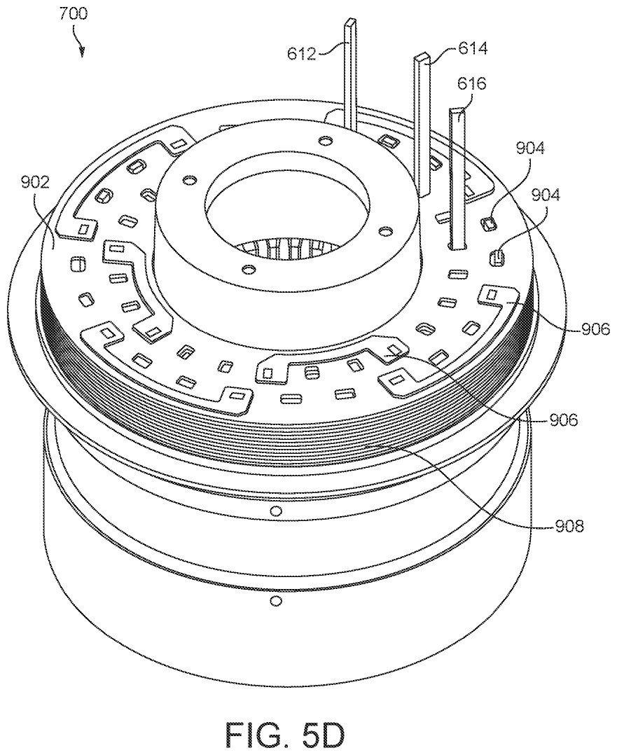

FIGS. 5a to 5d show a stator assembly 700 with connected coil windings at various stages of further assembly. FIGS. 5a-d show a ceramic plate and conductive busbar configuration positioned on the coil assembly 200 which enables the windings of each motor phase to be connected together whilst preventing wiring turns from different motor phases from contacting each other. Different plates and conductive busbars may be used for each electrical phase as discussed in further detail below. This arrangement for interconnecting the individual groups of windings improves the cooling of the coil winding turns 202 on the stator. In particular, the series of ceramic/ceramic coated plates 602, 702, 802, 902 and busbars 606, 706, 806, 906 provides an effective means for grouping the coil windings into electrical input phases, and further improves heat transfer away from the motor in operation.

FIGS. 5a to 5d show the coil winding assembly 200 as described with reference to FIGS. 2a to 2b. In the preferred embodiment, there is provided a first ceramic or ceramic-coated plate 602 having an annular shape (for example, through which a rotor can pass in use). In other examples, the first plate 602 may be a disc or other suitable shape. Again, alumina or magnesium oxide is preferably used as the ceramic material. In embodiments providing the curved ceramic surface 212 (i.e., the lamination end cap), the first plate 602 is provided at the second end 218 of the layered stack of laminations 115 opposite to the curved ceramic surface 212 which is positioned at the first end 216 of the layered stack of laminations 115. The first plate 602 is arranged to be orthogonal to the centre axis 210 of the stator and/or parallel to the layered stack of laminations 115.

The first plate 602 comprises a plurality of openings 604. These openings 604 are configured to receive portions of the coil winding turns 202 such that the inside or outside leg of each coil winding turn 202 extend through the openings 604. Coil winding turns 202 corresponding to a first electrical phase in use are connected together at the first plate 602 as described below, whereas coil winding turns corresponding to other, different phases pass through the first plate 602 without being connected together—these coil winding turns are connected together at further plates as described below.

At the first plate 602, a plurality of extended coil windings 608, 618 are arranged to extend through the first plate 602 without being connected to the first plate 602 or other segments of coil windings at the first plate 602.

FIG. 5a shows a plurality of connected coil winding turns 610a, 610b, 610c, 610d. The plurality of connected coil winding turns 610a, 610b, 610c, 610d which correspond to the first electrical phase are connected to one another using a plurality of first busbars 606a, 606b. Each connected coil winding turn 610a-610d is connected to at least one other connected coil winding turn 610a-610d using one of the plurality of first busbars 606a, 606b. In one example, the plurality of first busbars 606a, 606b embedded or recessed into the first ceramic plate 602 such that the first ceramic plate 602 and the plurality of first busbars 606a, 606b form a substantially planar surface. For example, connected coil winding turn 610a is connected to connected coil winding turn 610d using a first busbar 606a from the plurality of first busbars and connected coil winding turn 610b is connected to connected coil winding turn 610c using a second busbar 606b from the plurality of first busbars. A subset of the connected coil winding turns, such as connected coil winding turns 610b and 610c, are shortened such that the segment of coil winding does not extend further than the first ceramic plate 602. Another subset of the connected coil winding turns, such as connected coil winding turns 610a and 610d continue to extend through the openings 604 in the first ceramic plate 602 and protrude further than the first ceramic plate 602. In an example, no connected coil winding turns 610 extend further than the first ceramic plate 602.

Optionally, there may be an additional ceramic plate positioned adjacent to the layered stack of laminations 115 before the first ceramic plate 602. This ceramic plate may contain a plurality of openings to allow each coil winding to extend through. This ceramic plate may act as a spacer and does not have any busbars to connect coil windings at this stage.

FIG. 5b shows the stator configuration 700 with an additional ceramic plate 702 positioned axially adjacent to the first ceramic plate 602 shown in FIG. 5a.

The second ceramic plate 702 is placed axially to (for example, on top of or adjacent to) the first ceramic plate 602. The second ceramic plate 702 is orthogonal to the centre axis 210 of the stator and/or parallel to the layered stack of laminations 115. The second ceramic plate 702 is arranged with a plurality of openings 704. Preferably, the plurality of openings 704 of the second ceramic plate 702 are aligned with one or more openings 604 of the first ceramic plate 602. The plurality of openings second ceramic plate 702 may correspond to those provided in the first ceramic plate 602. Alternatively, the second ceramic plate 702 may contain a different number of openings to the first ceramic plate 602. Optionally, there are fewer openings provided in the second ceramic plate 702 compared to the first ceramic plate 602 as there are fewer coil winding turns protruding through to the second ceramic plate 702. The segments of coil winding turns 610b, 610c which are shortened at the first ceramic plate 602 cannot be seen in FIG. 5b but rather a plurality of openings 704 with no segments extending through are shown.

FIG. 5b shows a plurality of extended coil winding turns, such as coil winding turn 618. The extended coil winding turns 618 are arranged to extend through the second ceramic plate 702 without being connected to the second ceramic plate 702 or other segments of coil winding turns at the second ceramic plate 702.

FIG. 5b shows a plurality of connected coil winding turns 608a-608d. The connected coil winding turns 608 are connected to one another using a series of second busbars 706a-706b. For example, connected coil winding turn 608a is connected to connected coil winding turn 608b using a first busbar 706a from the plurality of second busbars and connected coil winding turn 608c is connected to connected coil winding turn 608d using a second busbar 706b from the plurality of second busbars. A subset of the connected coil windings, such as connected coil winding turns 608c, 608d, are shortened such that the segment of coil winding does not extend further than the second ceramic plate 702. Another subset of the connected coil winding turns, such as connected coil windings 608a, 608b continue to extend through the openings 704 in the second ceramic plate 702 and protrude further than the second ceramic plate 702.

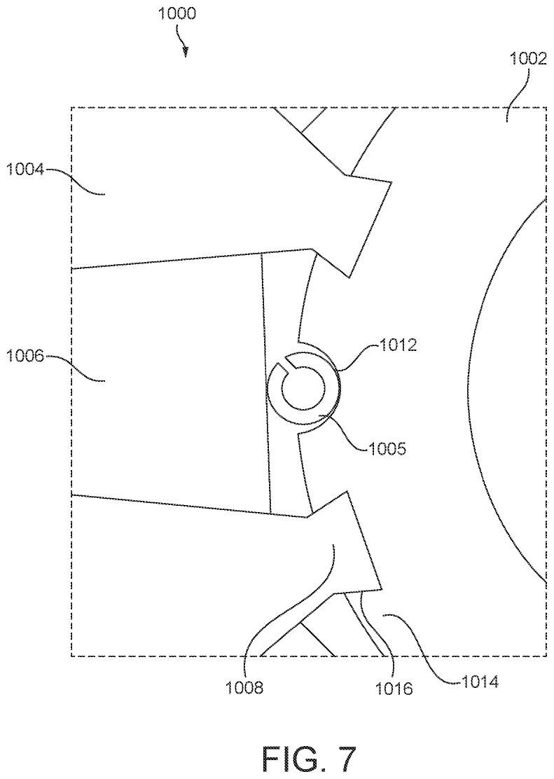

FIG. 5c shows the stator configuration 700 comprising an additional ceramic plate 802 positioned axially adjacent to the second ceramic plate 702 shown in FIG. 7b.

The third ceramic plate 802 is placed over the second ceramic plate 702. The third ceramic plate 802 is orthogonal to the centre axis 210 of the stator and/or parallel to the layered stack of laminations 115. The third ceramic plate 802 is arranged with a plurality of openings 804. Preferably, the plurality of openings 804 of the third ceramic plate 802 are aligned with one or more openings 604 of the first ceramic plate 602 and one or more openings 704 of the second ceramic plate 702. The third ceramic plate 802 may comprise more or, preferably, less openings 804 than the first ceramic plate 602 and/or the second ceramic plate 702. The segments of coil winding turns 608c, 608d which are shortened at the second ceramic plate 702 cannot be seen in FIG. 5c but rather a plurality of openings 804 with no segments extending through are shown.

FIG. 5c shows a plurality of extended coil windings 810. The extended coil winding turns 810 are arranged to extend through the third ceramic plate 802 without being connected to the ceramic plate 802 or other segments of coil winding turns at the third ceramic plate 802.

FIG. 5c shows a plurality of connected coil winding turns 618a, 618b as shown in FIG. 5c. The connected coil winding turns 618a, 618b are connected to one another using a series of third busbars such as busbar 806a. For example, connected coil winding turn 618a is connected to connected coil winding turn 618b using a first busbar 806a from the third plurality of busbars 802. Similar to FIGS. 5a and 5b, some of the connected coil winding turns 618 may be shortened at the ceramic plate 802 whilst some of the connected coil winding turns 618 may continue to extend through the openings 804 in the third ceramic layer 802. Alternatively, no connected coil winding turns 618 extend further than the third ceramic layer 802.

FIG. 5d shows stator configuration 700 comprising a final ceramic plate 902.

FIG. 5d shows a final ceramic plate 902 placed over (axially adjacent to) the third ceramic plate 802. The final ceramic plate 902 is orthogonal to the centre axis 210 of the stator and/or parallel to the layered stack of laminations 115. The final ceramic plate 902 is arranged with a plurality of openings 904. Preferably, the plurality of openings 904 of the final ceramic plate 902 are aligned with one of more of the openings 604 of the first ceramic plate 602, the openings 704 of the second ceramic plate 702, and the openings 804 of the third ceramic plate 802. Optionally, the final ceramic plate may comprise more or less openings than the other ceramic plates in the stator assembly. The segments of coil winding turns which are shortened at the third ceramic plate 802 cannot be seen in FIG. 5d but rather a plurality of openings 904 with no segments extending through are shown.

With the final ceramic plate 902, any remaining segments of coil winding turns which extend through the openings are connected using final busbars 906. In this way, all coil winding turns are connected to other turns corresponding to the same electrical phase using a series of ceramic plates 908 and a plurality of busbars, with three terminal coils 612, 614, and 616 (corresponding to each of the three phases) continuing to extend through and protrude from the final ceramic plate 902.

The first ceramic plate 602, the second ceramic plate 702, the third ceramic plate 802, and the final ceramic plate 902 are preferably formed from laser cut sheets. Preferably, the ceramic plates 602, 702, 802, 902 are formed from a ceramic with good thermal conductivity and poor electrical conductivity. For example, the ceramic may be alumina, alumina nitride, or magnesium oxide. The ceramic plates 602, 702, 802, 902 provide insulation and help to mitigate self-heating of the motor.

The busbars 606a, 606b, 706a, 706b, 806a, 906 may be formed from copper and may be laser, electron beam, or tungsten inert gas, TIG, welded to the coil windings. In another example, the coil windings may be connected by crimping or brazing, or via a suitable interference fit.

The stator assembly of FIGS. 5a-d prevents wiring turns from different motor phases (corresponding to terminal wires 612, 614, and 616) touching each other when routing the wires over each other and connects the windings of each phase together. For example, the first busbars 606a/b may be used for the first wiring phase connecting wires 610a 610b, 610c, 610d, the second busbars 706a, 706b may be used for the second wiring phase connecting wires 608a, 608b, 608c, 608d, and the third busbars 806a may be used for the third wiring phase connecting wires 618a, 618b. The final ceramic plate 902 insulates the whole assembly. This arrangement for interconnecting the individual groups of windings improves the cooling of the coil winding turns 202 on the stator. In use, the busbars lie in a cooler region of the motor away from the rotor, and provide a heatsink for the power dissipated in the windings.

In relation to FIGS. 5a to 5d, a skilled person would understand that any suitable number of ceramic plates and busbars may be used. A total of four ceramic plates (first, second, third and final ceramic plates) are shown for illustration purposes only. More or less ceramic plates may be used depending on the motor design.

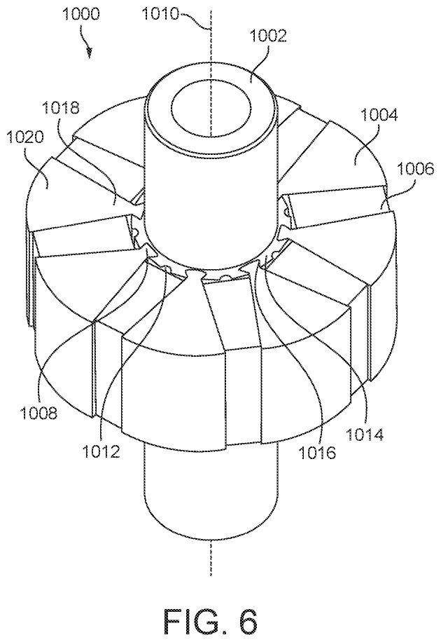

FIG. 6 shows a rotor configuration in accordance with an embodiment of the invention, which is compatible with the stator described above. FIG. 7 shows a cross section of a portion of the rotor of FIG. 6.

As noted previously, in use the rotor may in fact be stationary within the motor while the stator may rotate.

FIGS. 6 and 7 show a rotor 1000 with a shaft 1002 positioned around a centre axis 1010. The shaft 1002 is shaped to allow pole pieces 1004 to be slotted into the shaft 1002. In particular, the shaft 1002 is shaped to allow pole pieces 1004 to be slotted into the shaft 1002 in an axial direction, resulting in a joint that mechanically resists separation of the pole pieces 1004 from the shaft 1002 when subjected to forces in a radial direction. Preferably, the shaft 1002 has an integrated collar 1014 with a series of dovetail shaped axial slots 1016. Each pole piece 1004 has a corresponding dovetail portion 1008 that is slotted axially into a corresponding dovetail slot 1016 such that the shaft 1002 and the pole pieces 1004 are mechanically interlocking. Alternatively, the collar 1014 of the shaft 1002 may have slots 1016 of any shape where the width of the slot decreases in an outward radial direction towards an opening (in other words, the slot has a portion that is wider than its opening), and the pole pieces 1004 have a correspondingly shaped extending portion. The shaft 1002 and the pole pieces 1004 optionally correspond such that an interference fit is provided. Advantageously, this arrangement, acts to mechanically retain the pole pieces 1004 in the shaft 1002 under rotational forces of the motor without the need for any adhesive or other temperature-sensitive components.

Each pole piece 1004 of the plurality of pole pieces 1004 is shaped such that a narrower section 1018 of the pole piece 1004 is located closer to the centre axis 1010 and a wider portion 1020 of the pole piece 1004 is located further from the centre axis 1010. For example, the pole piece 1004 may comprise a dovetail portion 1008 connected to a fan cross section which tapers towards the centre axis 1010.

The rotor includes a magnet 1006 positioned between each pair of pole pieces 1004 such that the rotor arrangement is formed from a series of annularly alternating pole pieces 1004 and magnets 1006 around the centre axis 1010. A total of 8 pole pieces and 8 magnets are shown in FIG. 6 for illustration purposes only. A skilled person will understand that more or less pole pieces 1004 and magnets 1006 may be used, as long as the numbers are equal.

Each magnet 1006 is shaped to provide a wider portion closer to the centre axis 1010 and a narrower portion further from the centre axis 1010. For example, magnet 1006 may be wedge-shaped. In the illustrated embodiment, each magnet 1006 is shaped to fit within respective gaps between the pole pieces 1004 such that the widest portion of the magnet 1006 is adjacent to the narrowest portion of the pole piece 1004. Preferably, the magnets 1006 fit snugly (e.g. tightly, or as an interference fit) within the gaps provided by the plurality of pole pieces 1004 thereby interlocking the magnets 1006 between the plurality of pole pieces 1004.

Advantageously, this allows the magnets 1006 to be retained under rotation of the rotor without the use of adhesive or other fixing means that could degrade at high temperatures. Under a centrifugal force (i.e., rotation of the rotor), the magnets' 1006 load is transmitted to the pole pieces 1004, thus retaining the magnets 1006 between the pole pieces 1004.

Additionally, as best seen in FIG. 7, the rotor 1000 assembly uses a resiliently deformable member 1005, for example a spring pin, to secure the magnets 1006 in place. More particularly, resiliently deformable member may be a tubular metal spring pin. Such a resiliently deformable member 1005 is located within a groove 1012 which accommodates the resiliently deformable member. The groove 1012 may be of a semi-circular shape and is located within the collar of the shaft 1002 between the pole pieces 1004. The groove 1012 is located adjacent to each magnet 1006. The resiliently deformable members 1005 bias the plurality of magnets 1006 against the plurality of pole pieces 1004 and accommodate thermal differential expansion of the rotor assembly while ensuring that the magnets 1006 cannot become loose by ‘falling’ in towards the shaft 1002.

Magnets 1006 are optionally Recoma® HT grade magnets or equivalents thereof capable of operating above temperatures of 500 degrees C.

FIG. 8 shows a cross section of a motor 1100 comprising the stator assembly 700 discussed in relation to FIG. 1 to FIG. 5d and the rotor 1000 discussed in relation to FIG. 6.

Motor 1100 includes the stator and rotor described in relation to FIGS. 1-6. The rotor 1000 is installed within the annular opening 110 defined by the stator 700. FIG. 8 shows the shaft 1002 of the rotor with pole pieces 1004. Surrounding the pole pieces 1004 and magnets 1006 is the stator configuration. A cross section of the layered stack of laminations 115 is shown with the coil winding turns 202 wrapped over the curved ceramic surface 212. At an end of the shaft 1002 there is shown the layered stack of ceramic plates 908 (comprising the first, second, third, and final ceramic plates described above).

Surrounding the stator and rotor configuration there is provided a housing 1108. Internal to the housing there are first bearings 1110, and second bearings 1111 radially retaining the rotor shaft 1002 and allowing rotation of the shaft 1002. Bearings 1110 may be angular contact bearings as known in the art.

In the illustrated embodiment, the motor 1100 also comprises a means to accommodate thermal expansion including a spring member 1104 wherein the second bearing 1111 is able to slide axially along the shaft 1002. For example, spring member 1104 may be a wave spring. The motor 1100 further comprises a pair of spacers 1113a, 1113b, each spacer 1113a, 1113b being a sleeve positioned around the shaft 1002, optionally having an annular flanged shape as illustrated. The spacers 113a, 113b are positioned axially either side of the pole pieces 1004 and the magnets 1006. Each spacer 1113a, 1113b extends radially from the shaft 1002 such that a radially outermost edge of each spacer 1113a, 1113b lies at a greater radial distance from the shaft 1002 than a radially innermost portion of the pole pieces 1004 and a radially innermost portion of the magnets 1006. When the motor is assembled, the spring member 1104 is preloaded so as to apply an axial force to the second bearing 1111, which in turn transmits the force to the first spacer 1113a, through the rotor 1000, and through the second spacer 1113b to the first bearing 1110, the first bearing being fixed axially.

Advantageously, this arrangement allows for thermal expansion of all parts of the motor 1100 without subjecting any parts to high mechanical stress. Further, the use of the two spacers 1113a, 1113b provides an additional means for axially retaining the magnets 1006 and pole pieces 1004.

External to the motor housing are coil winding terminations 612, 614, and 616 corresponding to each of the three electrical phases.

The inside of the housing 1108 is coated in a ceramic coating. Such a coating may be provided by thermal spraying. The ceramic coating may be, for example, alumina. The ceramic coating prevents electrical contact of the coil winding turns 202 with the housing. A ceramic coating may also be provided on internal motor components. This is particularly useful where contact may occur with the conductors.

The approaches described herein allow for improved motor components operable at high temperatures. The stator component utilises ceramic components such that that the motor components are electrically isolated. Further, the ceramic components enable the motor to function at high temperatures and helps to mitigate self-heating of the stator. The rotor component allows for the assembly of components without the use of adhesive thus enabling the motor to operate at high temperatures.

It is to be understood that the foregoing embodiments are provided as examples only, and the at the invention is not limited to the described embodiments. The invention is defined by the appended independent claims, and encompasses all variations and equivalents that fall within the scope of the independent claims.

1. A stator for a brushless DC motor, the stator comprising:
a plurality of coil windings; and
a layered stack of laminations positioned around a centre axis, wherein the layered stack of laminations defines an annular shape, and wherein each lamination from the layered stack of laminations has:
a first plurality of teeth, wherein the first plurality of teeth extend radially towards the centre axis and define a first plurality of channels between the first plurality of teeth, wherein each channel of the first plurality of channels is configured to receive at least a first portion of a respective coil winding;
a second plurality of teeth, wherein the second plurality of teeth extend radially away from the centre axis and define a second plurality of channels between the second plurality of teeth, wherein each channel of the second plurality of channels is configured to receive at least a second portion of a respective coil winding;
wherein each of the first plurality of channels and the second plurality of channels is provided with a layer of electrically insulating ceramic material such that each coil winding of the plurality of coil windings is electrically insulated from the layered stack of laminations; and
wherein the layer of electrically insulating ceramic material comprises at least one of a solid ceramic insert having a substantially U-shaped cross section and a vapor deposition coating.

2. The stator of claim 1, comprising:
a lamination end cap;
wherein the lamination end cap has an annular shape positioned around the centre axis adjacent to the layered stack of laminations; and
wherein the lamination end cap has a curved ceramic surface with a curvature about an annular axis.

3. The stator of claim 2, wherein the lamination end cap has a half torus shape.

4. The stator of claim 2 wherein:
a first coil winding of the plurality of coil windings has a substantially U-shaped section including an inside leg, an outside leg, and a curved portion;
the inside leg of the first coil winding of the plurality of coil windings lies within one of the first plurality of channels;
the outside leg of the first coil winding of the plurality of coil windings lies within one of the second plurality of channels; and
the curved portion of the first coil winding of the plurality of coil windings sits adjacent to the curved ceramic surface.

5. The stator of claim 4, comprising one or more conductive connectors extending between the first coil winding of the plurality of coil windings and a second coil winding of the plurality of coil windings different to the first coil winding and arranged such that the inside leg of the first coil winding of the plurality of coil windings is connected to an outside leg of a the second coil winding of the plurality of coil windings different to the first coil winding.

6. The stator of claim 5, wherein the one or more conductive connectors extending between the first coil winding of the plurality of coil windings and a second coil winding of the plurality of coil windings different to the first coil winding comprises one or more busbars welded to an end of the inside leg of the first coil winding of the plurality of coil windings and welded to an end of the outside leg of the second coil winding of the plurality of coil windings.

7. (canceled)

8. The stator of claim 1, wherein each coil winding of the plurality of coil windings is formed from copper plated with nickel.

9. The stator of claim 1, comprising:
a first plate formed from ceramic or coated with ceramic;
a first conductive busbar positioned on the first plate;
a second plate formed from ceramic or coated with ceramic;
a second conductive busbar positioned on the second plate;
wherein each of the plurality of coil windings has an elongate portion;
wherein a first elongate portion of a first coil winding and a second elongate portion of a second coil winding are connected via the first conductive busbar; and
wherein a third elongate portion of a third coil winding and a fourth elongate portion of a fourth coil winding extend through the first plate and are connected via the second conductive busbar.

10. The stator of claim 1, wherein the layer of electrically insulating ceramic material is one or more of alumina or magnesium oxide.

11. A rotor for a brushless DC motor, the rotor comprising:
a shaft positioned around a centre axis, the shaft comprising a plurality of axially extending slots, the slots having an annular width that decreases radially towards an opening;
a plurality of pole pieces spaced at intervals around the shaft and extending radially away from the centre axis, wherein each pole piece of the plurality of pole pieces comprises a radially extending portion configured to be slotted axially into a corresponding slot of the plurality of slots, and wherein the radially extending portion has a cross section shaped to correspond with a cross section of the slot; and
a plurality of magnets, wherein each magnet of the plurality of magnets is positioned between a first pole piece and second pole piece of the plurality of pole pieces;
wherein each of the plurality of magnets is biased against the plurality of pole pieces by means of a radially resiliently deformable member positioned between each of the plurality of magnets and the shaft; and
wherein the radially resiliently deformable member is a spring pin.

12. The rotor of claim 11, wherein:
each magnet of the plurality of magnets is shaped to define a first portion having a larger annular width than a second portion, the first portion being radially closer to the centre axis than the second portion;
each pole piece of the plurality of pole pieces is shaped to define a first region having a smaller annular width than a second region, the first region being radially closer to the centre axis than the second region;
such that the plurality of magnets are mechanically retained by the plurality of pole pieces under rotation of the rotor.

13. The rotor of claim 11, wherein each magnet of the plurality of magnets is wedge shaped.

14. (canceled)

15. A brushless DC motor comprising the rotor of claim 11.

16. The brushless DC motor of claim 15, comprising:
a first bearing and a second bearing;
wherein the first bearing is fixed axially relative to the shaft and the second bearing is axially movable relative to the shaft; and
an axially resiliently deformable member;
wherein the axially resiliently deformable member is configured to apply an axial force to the second bearing, which is transmitted through the rotor, to the first bearing.

17. The brushless DC motor of claim 16, comprising:
a spacer surrounding a portion of the shaft;
the spacer positioned so as to separate the second bearing from the plurality of pole pieces and the plurality of magnets; and
wherein the spacer extends radially from the shaft such that a radially outermost edge of the spacer lies at a greater radial distance from the shaft than a radially innermost portion of the plurality of pole pieces and a radially innermost portion of the plurality of magnets.

18. A brushless DC motor comprising the stator of claim 1.
